(19) United States
(12) Patent Application Publication
(10) Pub. No.: US 2007/0034473 A1
(43) Pub. Date: Feb. 15, 2007

(54) Overload clutch

(76) Inventor: Jurgens Gunter, Portschach (AT)

Correspondence Address: WILLIAM COLLARD;COLLARD & ROE, P.C., 1077 NORTHERN BOULEVARD, ROSLYN, NY, 11576, US

(21) Appl. No.: 10/566,610

(22) PCT Filed: Jun. 29, 2004
(86) PCT No.: PCT/AT04/00272

§ 371 Date: Sep. 12, 2006

(30) Foreign Application Priority Data
Aug. 1, 2003 (AT) A 1219/2003

(51) Int. Cl. F16D 7/02; F16D 43/20

(52) U.S. Cl. 192/56.61

(57) ABSTRACT

An overload clutch is described, having two clutch bodies (11, 12), one of which is mounted rotationally fixed and the other of which is mounted so it is rotatable on a clutch carrier (3), and which may be coupled in the axial direction, of which the axially displaceably mounted clutch body (12) is impinged to disengage, and having a holding unit adjustable as a function of the size of the transmitted torque for the clutch engagement. In order to provide advantageous triggering conditions, it is suggested that the holding unit comprise a switching unit (16), which releases the axial actuator travel of the displaceably mounted clutch body (12) and may be actuated by an actuating drive connected to an energy accumulator (23).

### 1. FIELD OF THE INVENTION

The present invention relates to an overload clutch having two clutch bodies, one of which is mounted rotationally fixed and the other of which is mounted rotatably on a clutch carrier, and which may be coupled in the axial direction, of which the axially displaceably mounted clutch body is impinged to disengage, and having a holding unit, which is adjustable as a function of the size of the torque transmitted, for the clutch engagement.

### 2. DESCRIPTION OF THE PRIOR ART

In a known overload clutch of this type (DE 43 00 952 A1), the clutch carrier, which is implemented as a hub, carries a claw collar having radially oriented claws. This claw collar, which is connected rotationally fixed to the clutch carrier, has a claw collar having axially oriented claws assigned to it, which is mounted on the clutch carrier so it is freely rotatable via a ball bearing. Spherical pressure transmission bodies are provided between the claws of the two claw rings, which are pressed with the aid of a pressure ring in the axial direction against the claw collar rotatably mounted on the clutch carrier, whose claw teeth act with the pressure transmission bodies engaging in these teeth like a wedge transmission, which is impinged by the torque to be transmitted to disengage the pressure transmission bodies from the claw teeth of the claw collar rotatably mounted on the clutch carrier. In this case, the pressure ring forms a holding unit for the axial clutch engagement of the pressure transmission bodies in the axially oriented claw teeth of the rotatably mounted claw collar. If the axial disengagement force, which is exerted on the pressure transmission bodies and is a function of the torque transmitted, exceeds the opposing force of a clutch spring axially impinging the pressure ring, the pressure ring is pushed against the force of the clutch spring via the pressure transmission bodies until the pressure transmission bodies come out of the claw teeth of the claw collar rotatably mounted on the clutch carrier and release the clutch element connected rotationally fixed to this claw collar. These known overload clutches have the disadvantage above all that the clutch spring does not only determine the transmittable torque, but rather also the force with which the pressure ring must be impinged via the pressure transmission bodies to disengage the clutch engagement, which causes tolerance ranges for the delimitation of the maximum transmittable torque between the input and output clutch elements that cannot fulfill higher requirements on the triggering safety of such overload clutches.

### SUMMARY OF THE INVENTION

The present invention is thus based on the object of implementing an overload clutch of the type described at the beginning in such way that the tolerance range provided for the safe triggering of the overload clutch upon occurrence of an overload may be decisively reduced.

The present invention achieves the object stated in that the holding unit comprises a switching unit, which releases the axial actuator travel of the displaceably mounted clutch body and which may be actuated by an actuating drive connected to an energy accumulator.

Since, as a result of these measures, the energy required for adjusting the holding unit is applied independently of the maximum transmittable torque by a separate energy accumulator, the acquisition of the transmitted torque may be assigned separately by assemblies separate from the triggering of the clutch, which represents a significant requirement for maintaining narrow tolerance ranges for the triggering of the overload clutch. In addition, the holding unit comprises a switching unit which is actuated upon response of the overload clutch by an actuating drive impinged by the energy accumulator and releases the displacement path of the displaceably mounted clutch body, so that very small operating times may be ensured for the overload clutch. The energy required for disengaging the clutch body which is engaged may be provided in a known way through the torque active between the coupled clutch bodies, for example, if clutch teeth are provided between the clutch bodies which impinge the clutch bodies to disengage due to the torque to be transmitted like a wedge transmission. However, separate energy accumulators may also be provided for impinging the clutch bodies to disengage, which are necessary when the clutch engagement occurs via friction lamellae.

Although the holding unit may be constructively implemented in different ways, especially simple construction conditions result if the holding unit has a support ring, which is axially supported via axial cams on a collar of roller bodies and is coaxial to the clutch carrier, and which is rotatable by the switching unit in relation to the roller body collar between a lock position and a release position, delimited by stops. The cams of the support ring determine the axial support ring position in this case as a function of the rotational position of the support ring in relation to the clutch carrier and thus determine the lock and/or release positions for the displaceably mounted clutch body.

The switching unit required for rotating the support ring may have a switching disk, which is rotatably mounted on the clutch carrier, delimited by stops, and is impinged via springs acting around the circumference as an energy accumulator, which works together with a locking unit which may be loosened as a function of the transmitted torque. If the locking unit is loosened upon exceeding the predefined limiting torque, the springs acting around the circumference cause the rotation of the switching disk in relation to the clutch carrier, which, if the switching disk is connected to the support ring, also causes the displacement of the support ring from its lock position into the release position for the displaceably mounted clutch body.

In order to provide advantageous conditions for the acquisition of the limiting torque to be transmitted, the clutch carrier may be connected to a driving clutch element under a torque load, which acts in opposition to the torque of the driving clutch element and determines the transmittable torque, so that the transmitted torque reduces the torque pre-tension acting between the clutch carrier and the driving clutch element. The actuating drive for the switching unit may therefore be activated as a function of the particular active torque between the clutch carrier and the driving clutch element. For this purpose, the clutch carrier and the driving clutch element may be connected by at least one bolt rotatably inserted into aligned holes of the clutch carrier and the clutch element, the locking unit for the switching disk comprising an eccentric pin of this bolt engaging in a guide link of the switching disk. Since the bolt represents a torque support between the clutch carrier and the driving clutch element, it is held friction-locked in the holes of these construction parts by opposing forces because of the torque pre-tension between the clutch carrier and the driving clutch element, which is reduced as the transmitted torque increases, because the torque pre-tension between clutch carrier and driving clutch element is reduced. The friction lock between the bolt and the holes receiving it which prevents rotation of the bolt is reduced until reaching the limiting torque set via the torque pre-tension, so that upon exceeding this limiting torque, it is possible to rotate it via an eccentric pin of this bolt engaging in a guide link of the switching disk. Since the switching disk is impinged with a corresponding torque via an energy accumulator, the bolt is rotated via the eccentric pin engaging in the guide link, the eccentric pin being displaced radially and releasing the rotational movement of the switching disk in relation to the clutch carrier as soon as this pin enters a link section running around the circumference from an essentially radially running section of the guide link. The loosening of the locking unit connected thereto results in the rotation of the support ring connected to the switching disk from the lock position into the release position, in which the clutch body disengages from the clutch engagement.

After the overload clutch is triggered, not only is the clutch engagement between the clutch bodies to be produced again, but rather also the energy accumulator provided to the actuating drive for the switching unit is to be tensioned again. This may be achieved constructively in that the switching disk is pivotably connected to a stop disk, delimited by stops, the springs of the energy accumulator are clamped between the stop disk and the switching disk, and the stop disk is rotationally adjustable in relation to the clutch body via an actuating eccentric mounted in the clutch carrier or in the driving clutch element. With the triggering of the locking unit and the release of the energy accumulator, the switching disk is pivoted by the springs of the energy accumulator in relation to the stop disk, which is held rotationally fixed by the actuating eccentric in relation to the clutch carrier and/or the driving clutch element. For the new tensioning of the energy accumulator, the stop disk is thus to be rotated back into the starting position in relation to the switching disk, the switching disk additionally having to be locked. For this purpose, the actuating eccentric for the stop disk is pivoted to rotate the switching disk back. During this rotation back of the switching disk, the eccentric pin of the bolt of the locking unit slides out of the link section running around the circumference into the radial section of the guide link, through which the rotational position of the switching disk is locked. The torque which may be exerted via the actuating eccentric on the switching disk must be sufficiently large to overcome the friction lock of the bolt carrying the eccentric pin caused by the torque pre-tension between clutch carrier and driving clutch element. After the locking of the switching disk in the starting rotational position, the stop disk may also be rotated back into the starting position via the actuating eccentric, which is now connected to tensioning of the energy accumulator, because the switching disk is locked rotationally fixed in relation to the clutch carrier and/or the clutch element.

Since a return of the actuating drive for the switching unit is also connected to the rotation of the switching disk back into the starting position, which in turn causes the clutch engagement of the clutch body, the overload clutch is ready for use again after the tensioning of the energy accumulator via the actuating eccentric.

Although the torque pre-tension between the clutch carrier and the driving clutch element may be ensured in different constructions, especially space-saving construction conditions result if a coaxial torsion bar is clamped between the clutch carrier and the driving clutch element under pre-tension.

In order to also be able to compensate for angle and alignment errors between the drive and output shafts with the aid of the overload clutch, the output-side clutch body of the two clutch bodies may be connected to drive a driven clutch element via a sleeve enclosing the clutch carrier to compensate for such angle and alignment errors, so that additional compensation clutches are dispensed with.

### BRIEF DESCRIPTION OF THE DRAWING

The object of the present invention is illustrated as an example in the drawing.

FIG. 1 shows an overload clutch according to the present invention in a schematic axial section,

FIG. 2 shows a section along the line II-II of FIG. 1 in an enlarged scale,

FIG. 3 shows a section along the line III-III in an enlarged scale,

FIG. 4 shows a section along the line IV-IV of FIG. 2 in an enlarged scale,

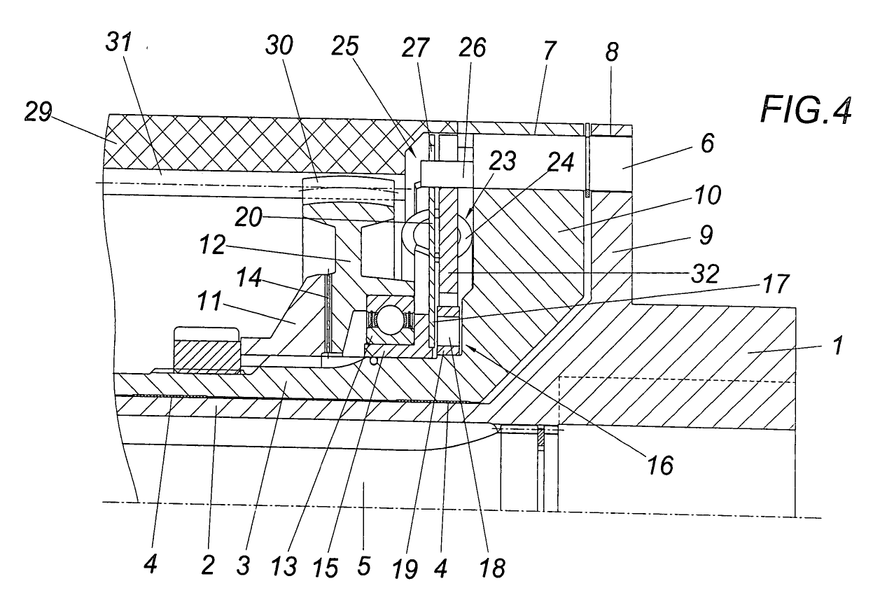

FIG. 5 shows a section along the line V-V of FIG. 3 in an enlarged scale, and

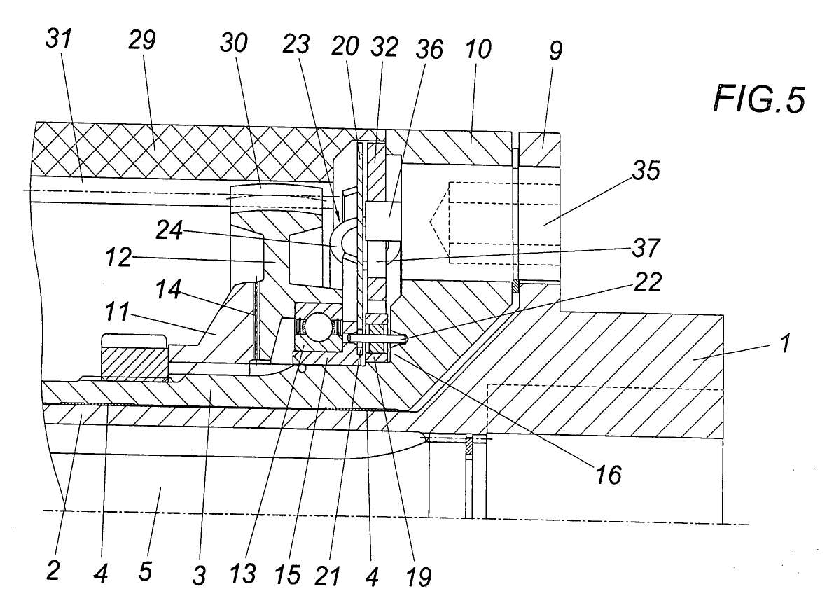

FIGS. 6 and 7 show a section along the line VI-VI of FIG. 1 in a schematic developed view for the engaged and disengaged overload clutch in an enlarged scale.

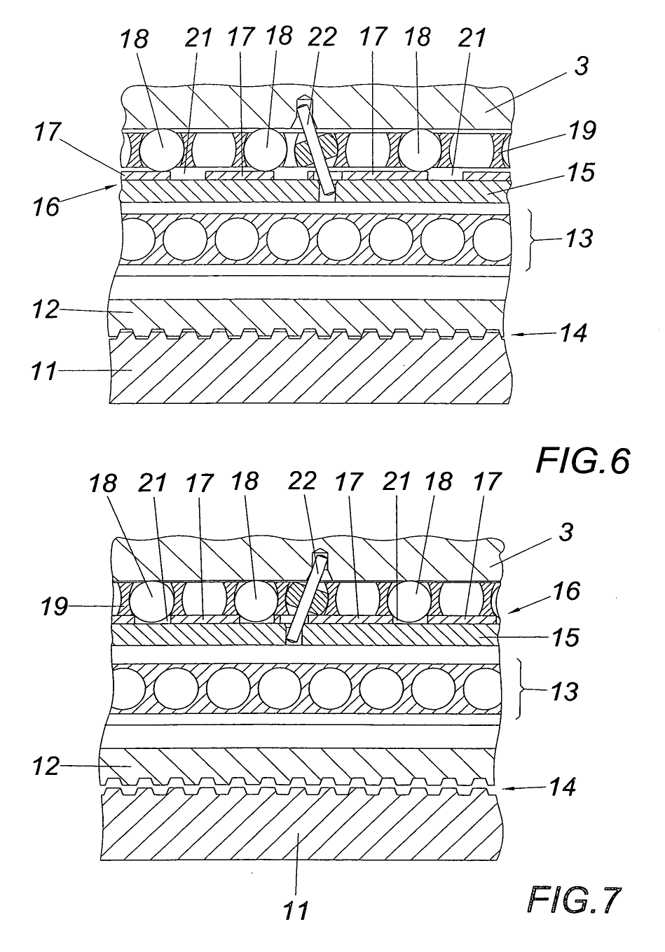

### DESCRIPTION OF THE PREFERRED EMBODIMENTS

The overload clutch according to the exemplary embodiment shown has, on the drive side, a driving clutch element 1 connectable to an output shaft, which forms a bearing sleeve 2 for a clutch carrier 3, which is supported on the bearing sleeve 2 via a friction bearing 4. The clutch carrier 3 and the driving clutch element 1 are connected to drive one another via a pre-tensioned torsion rod 5. The torque pre-tension between the clutch element 1 and the clutch carrier 3 caused by the torsion rod 5 is absorbed by bolts 6, which are inserted into aligned holes 7, 8 of two diametrically opposite flanges 9, 10 of the clutch element 1 and the clutch carrier 3.

Two clutch bodies 11, 12 are positioned on the clutch carrier 3, of which one clutch body 11 is connected rotationally fixed to the clutch carrier 3, while the other clutch body 12 is mounted rotatably on the clutch carrier 3 via a roller bearing 13. This clutch body 12, which may be coupled to the clutch body 11 in the axial direction via front clutch teeth 14, is additionally positioned so it is axially displaceable on the clutch carrier 3 via a support ring 15 receiving the roller bearing 13. The support ring 15 is held in a lock position, which ensures the clutch engagement of the clutch teeth 14, by a switching unit 16, and may be released to disengage the clutch teeth 14 by actuating the switching unit 16. For this purpose, the support ring 15 is supported via axial cams 17 on a collar of roller bodies 18, which are held in a cage 19 connected rotationally fixed to the clutch carrier 3. An actuating drive is used for the rotational adjustment of the cams 17, which is formed by an annular switching disk 20 coaxial to the clutch carrier 3, which is connected rotationally fixed to the support ring 15 and provides the axial cams 17 between recesses 21 in the area of its internal circumference. The possible rotational angle between the clutch body 3 and the support ring 15 is fixed by clutch pins 22, which are mounted in the cage 19 of the roller body collar and engage in receiving holes of the clutch carrier 3 and, in addition, the support ring 15. An energy accumulator 23, which is constructed from springs 24 acting around the circumference and distributed around the circumference, is used for the rotational adjustment of the switching disk 20.

In the rotational position of the switching disk 20 ensuring the clutch engagement, the switching disk is supported rotationally fixed in relation to the clutch carrier 3 by a locking unit 25. This locking unit 25 is formed by an eccentric pin 26 provided on the bolt 6, which engages in a guide link 27 of the switching disk 20. This guide link 27 has a radially running section blocking the rotation of the switching disk 20 and an adjoining link section, running around the circumference, which releases the rotation of the switching disk 20.

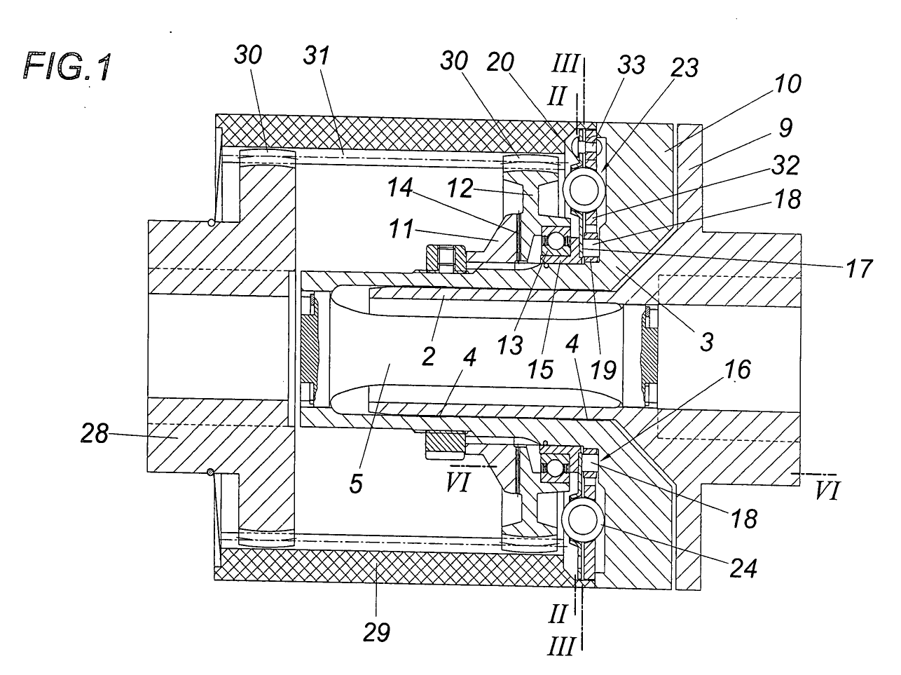

As already noted, the bolt 6 is pressed between the flanges 9, 10 of the driving clutch element 1 and the clutch carrier 3, which are held mutually under a torque pretension, around the circumference of these flanges against the walls of the holes 7, 8, so that the friction lock between the bolt 6 and the walls of the holes 7, 8 thus caused prevents rotation of the bolt 6 and therefore the eccentric pin 26. Since the torque pre-tension between the clutch element 1 and the clutch carrier 3 is directed by the torsion bar 5 in opposition to the torque to be transmitted by the clutch element 1 to the clutch carrier 3, the torque pre-tension between the clutch element 1 and the clutch carrier 3 is reduced with the increase of the drive torque, with the result that the friction lock of the bolt 6 in the receiving holes 7, 8 is correspondingly reduced until the torque exerted by the energy accumulator 23 on the switching disk 20 is sufficient to pivot the bolt 6 via the eccentric pins 26. This means that the eccentric pins 26 come out of the radial sections of the guide link 27 into the guide sections running around the circumference, because of which the rotation of the switching disk 20 is released, so that the cams 17 are pivoted out of the support area of the roller bodies 18 and the roller bodies 18 engage in the recesses 21 between the cams 17. The release position of the switching unit thus reached allows an axial adjustment of the clutch body 12, which is impinged via the clutch teeth 14 to disengage, so that upon reaching the release position, the clutch bodies 11, 12 are suddenly decoupled, which results in the interruption of the drivetrain between the driving clutch element 1 and the output-side, driven clutch element 28, which is connected to the clutch body 12 via a sleeve 29 for the compensation of angle and alignment errors. As may be inferred from FIG. 1, the driven clutch element 28 and the clutch body 12 each form spur gears having crowned teeth 30, which work together with internal teeth of the sleeve 29, for this purpose.

In order to reproduce the operational readiness after a response of the overload clutch, not only does a clutch engagement of the clutch teeth 14 between the clutch bodies 11, 12 have to be ensured, but rather also tensioning of the relaxed energy accumulator 23 to drive the switching disk 20. This is achieved according to the exemplary embodiment shown in that a stop disk 32 is assigned to the switching disk 20, which is mounted in relation to the switching disk 20 so it is rotatable via guide pins 33, delimited by stops, which engage in oblong holes 34. The rotational position of the switching disk 32 is determined by an actuating eccentric 35, which is mounted so it is rotationally adjustable in the flange 9 or 10 of the clutch element 1 and/or the clutch carrier 3, whose eccentric actuating element 36 engages in a radial oblong hole 37 of the stop disk 32.

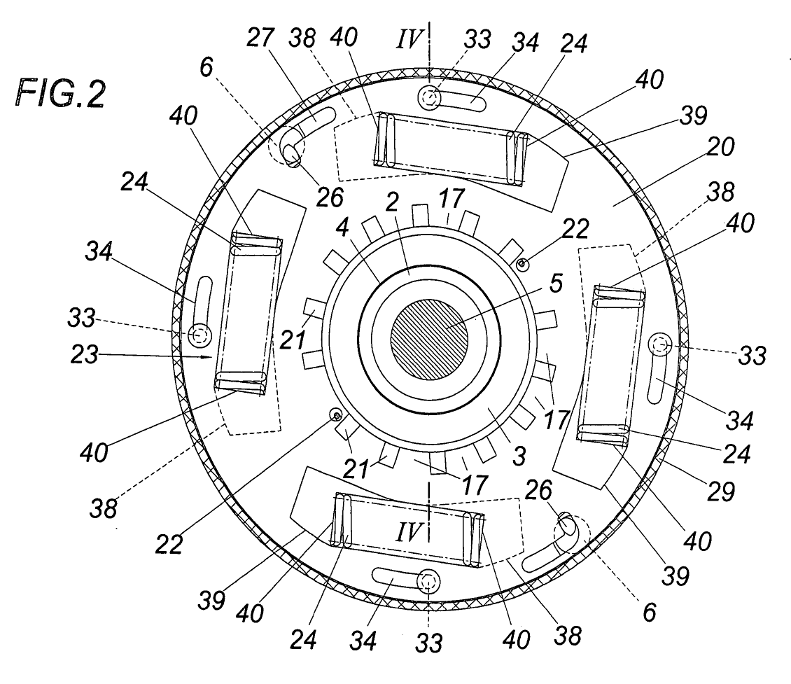

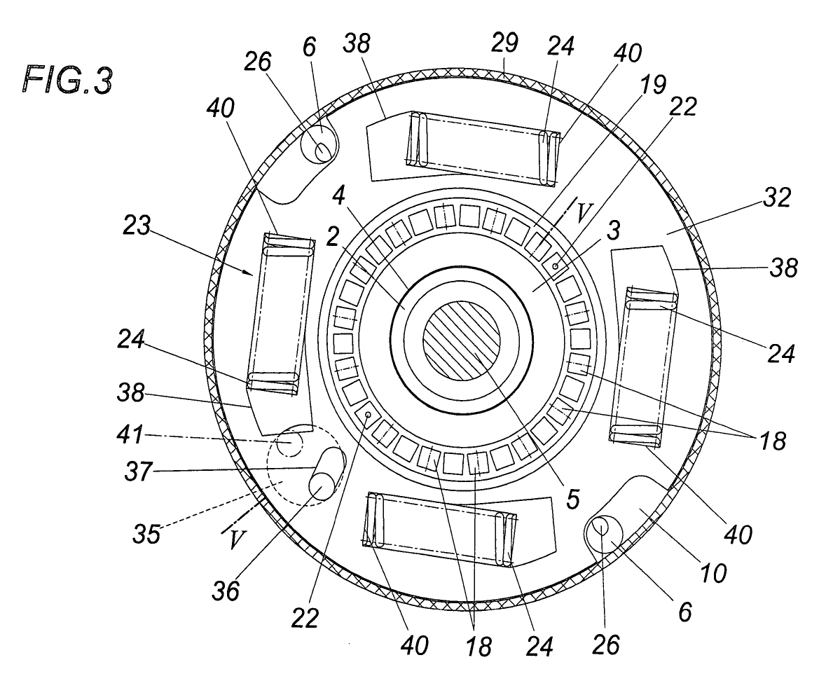

As may be seen from FIG. 2 in particular, the springs 24 of the pressure accumulator 23 are inserted into recesses 38 of the stop disk 32 and recesses 39 of the switching disk 20, the peripheral ends of these recesses 38, 39 facing away from one another forming buttresses 40 for supporting the springs 24. If the stop disk 32 is fixed in the base position shown in FIG. 3 via the actuating eccentric 35, which assumes a dead center position in this position, and the locking unit 25 is loosened when the transmittable limiting torque is exceeded, the energy accumulator 23 formed by the springs 24 causes impingement of the switching disk 20 counterclockwise in the illustration of FIG. 2, which results in unlocking due to the eccentric pins 26 rotated clockwise and thus the disengagement of the clutch teeth between the clutch bodies 11, 12. In order to ensure the clutch engagement after engagement of the clutch teeth 14, the switching disk 20 must be rotated back into the starting position shown in FIG. 2. For this purpose, the actuating eccentric 35 is rotated counterclockwise as shown in FIG. 3, which results in the stop disk 32 being carried clockwise. Because of the forced carrying of the switching disk 20 via the guide pins 33, which stop at the other oblong hole end in relation to FIG. 2, the eccentric pins 26 may, in spite of the friction lock of the bolts 6, be rotated back via the link guide 27 into the locking position shown in FIG. 2, so that the switching disk 20 is locked via the eccentric pins 26 in the area of the dead center position 41 of the actuating element 36 of the actuating eccentric 35 indicated by a dot-dash line in FIG. 3, but with the energy accumulator 23 still relaxed. Therefore, the actuating eccentric 37 is to be rotated back to tension the springs 24, the spring accumulator 23 being tensioned because the switching disk 20 is secured against being rotationally carried by the locking unit 25. As the stop disk 32 rotates back into its starting position, the operational readiness of the overload clutch is produced again. The rotation of the actuating eccentric 35 may advantageously be performed via a tool which may be actuated by hand, for example by a hand crank provided with a corresponding plug-in projection.

The pre-tension of the torsion bar 5 may be set to set the particular triggering torque required, as is known per se.

Of course, the present invention is not restricted to the exemplary embodiment shown, if the implementation of the clutch engagement of the clutch bodies 11, 12 is not of interest, for example, but rather that the holding unit ensuring the clutch engagement acts as a switching unit, which is actuated via an energy accumulator and releases the axial actuator path of the displaceably mounted clutch body at the same time, which is impinged either by the torque to be transmitted or by a separate energy accumulator so it disengages.

1. An overload clutch having two clutch bodies, one of which is mounted rotationally fixed and the other of which is mounted so it is rotatable on a clutch carrier, and which may be coupled in the axial direction, of which the axially displaceably mounted clutch body is impinged to disengage, and having a holding unit adjustable as a function of the size of the transmitted torque for the clutch engagement, wherein the holding unit comprises a switching unit (16), which releases the actuator travel of the displaceably mounted clutch body (12), and which may be actuated by an actuating drive connected to an energy accumulator (23).

2. The overload clutch according to claim 1, wherein the holding unit has a support ring (15), which is axially supported via axial cams (17) on a collar of roller bodies (18) and is coaxial to the clutch carrier (3), and which is rotatable by the switching unit (16) between a lock position and a release position in relation to the roller body collar, delimited by stops.

3. The overload clutch according to claim 1, wherein the switching unit (16) has a switching disk (20), which is rotatably mounted, delimited by stops, on the clutch carrier (3) and is impinged via springs (24) acting around the circumference as the energy accumulator (23), and a locking unit (25) for the switching disk (20), which may be loosened as a function of the transmitted torque.

4. The overload clutch according to claim 1, wherein the clutch carrier (3) is connected to a driving clutch element under a torque load, acting opposite to the torque of the driving clutch element (1), which determines the transmittable torque, and the actuating drive may be activated as a function of the particular torque acting between the clutch carrier (3) and the driving clutch element (1).

5. The overload clutch according to claim 3, wherein the clutch carrier (3) and the driving clutch element (1) are connected by at least one bolt (6), which is rotatably inserted into aligned holes (7, 8) of the clutch carrier (3) and the clutch element (1), and the locking unit (25) for the switching disk (20) comprises an eccentric pin (26) of this bolt (6) engaging in a guide link (27) of the switching disk (20).

6. The overload clutch according to claim 5, wherein the switching disk (20) is rotatably connected to a stop disk (32), delimited by stops, the springs (24) of the energy accumulator (23) are clamped between the stop disk (23) and the switching disk (20), and the stop disk (32) is rotationally adjustable in relation to the clutch carrier (3) and/or the clutch element (I) via an actuating eccentric (35) mounted in the clutch carrier (3) or in the driving clutch element (I).

7. The overload clutch according to claim 4, wherein a coaxial torsion rod (5) is clamped under pre-tension between the clutch carrier (3) and the driving clutch element (1).

8. The overload clutch according to claim 1, wherein the output-side clutch body of the two clutch bodies (11, 12) is connected to drive a driven clutch element (28) via a sleeve (29), which encloses the clutch carrier (3), to compensate for angle and alignment errors.
